(19) United States
(12) Patent Application Publication
(10) Pub. No.: US 2026/0148281 A1
(43) Pub. Date: May 28, 2026

(54) TRANSFORMER-BASED RECOMMENDER SYSTEM USING REINFORCEMENT LEARNING AND DIRECT PREFERENCE OPTIMIZATION

(71) Applicant: Home Depot Product Authority, LLC, Atlanta, GA (US)

(72) Inventors: Ankur Porwal, Atlanta, GA (US); Ding Xiang, Atlanta, GA (US); Xiquan Cui, Atlanta, GA (US); Anvesh Sati, Atlanta, GA (US)

(21) Appl. No.: 19/402,499

(22) Filed: Nov. 26, 2025

Related U.S. Application Data
(60) Provisional application No. 63/725,974, filed on Nov. 27, 2024.

(51) Int. Cl. G06Q 30/0601; G06N 3/048

(52) U.S. Cl. CPC G06Q 30/0631; G06N 3/048

(57) ABSTRACT

Systems and methods for training a first model using reinforcement learning can include, for a first input sequence of one or more first input sequences, obtaining the first input sequence, predicting, by a first model, a set of candidate items as recommendations based on the first set of items, sending the set of candidate items to a user computing device, obtaining feedback data corresponding to a second input sequence, determining a first value for a first item and a second value for a second item, the first value and the second value representative of predictive probabilities of the first model, determining a training dataset including a plurality of data points, each data point including a weighted score, and training the first model using the training dataset to update one or more parameters of the first model to minimize a prediction loss by the first model.

### CROSS-REFERENCE TO RELATED APPLICATION

This application claims the benefit of priority to U.S. provisional application No. 63/725,974, filed Nov. 27, 2024, which is hereby incorporated by reference in its entirety.

### FIELD

The present disclosure relates to the field of recommender systems. More particularly, training recommender systems using reinforcement learning with user feedback.

### BACKGROUND

Recommender systems enable an entity such as, for example, an online merchant to personalize the offerings of goods or services to a user during an online session at a user interface. The recommender system can predict the offerings to provide to the user according to, for example, the user's interests, inputs at the user interface during a current session or past sessions, etc. The recommender system can identify the user's intention during the session based on the user's inputs at the user interface and can predict one or more offerings to provide to the user through the user interface. The offerings predicted by the recommender system can facilitate discovery of relevant or related offerings that facilitates user interaction and facilitates completion of electronic transaction related to the current session.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram of an example system for training a base transformer model using reinforcement learning with feedback data, according to some embodiments.

FIG. 2 is a block diagram of an example framework for training a model of the RL recommender system of FIG. 1 using reinforcement learning with user feedback, according to some embodiments.

FIG. 3 is a block diagram of an example training dataset for training the model of RL recommender system in FIG. 1, according to some embodiments.

FIG. 4 is a block diagram of an example transformer model of FIG. 1, according to some embodiments.

FIG. 5 is a block diagram of an example transformer model of FIG. 1, according to some embodiments.

FIG. 6 is a flow diagram of an example transformer model of FIG. 1, according to some embodiments.

FIG. 7 is a flow diagram of an example method for training the recommender system using reinforcement learning with user feedback data, according to some embodiments.

FIG. 8 is a flow diagram of an example method for determining a training dataset, according to some embodiments.

FIG. 9 is a flow diagram of an example method for determining the training dataset, according to some embodiments.

FIG. 10 is a flow diagram of an example method for determining the training dataset, according to some embodiments.

FIG. 11 is a block diagram of an example model of the RL recommender system in FIG. 1, according to some embodiments.

FIG. 12 is a graphical illustration of an example computing system, according to some embodiments.

### DETAILED DESCRIPTION

Recommender systems generally enable an entity such as, for example, an online merchant to personalize the offerings of goods or services to a user during an online session at a user interface. The recommender system can predict the offerings according to, for example, the user's interests, inputs at the user interface during a current session or past sessions, etc. Recommender systems typically leverage self-attention-based transformer models to predict offerings to a user based on user inputs corresponding to user interactions with offerings during a current session and/or offerings during past sessions.

Various embodiments of the present disclosure relate to systems and methods for a recommender system that can be configured to apply an input sequence obtained from a user interface during a current session to a transformer model to predict one or more candidate items as recommendations, and for training the model using reinforcement learning with user feedback obtained during the current session to finetune the model and update one or more parameters of the model so as to minimize a prediction loss between the candidate items and the feedback data.

According to various embodiments, the recommender system can include a processor and a memory device such as, for example, a non-transitory, computer-readable medium having stored thereon instructions that are executable by the processor to perform one or more operations in accordance with the present disclosure. The recommender system can perform operations including, but not limited to, obtain one or more first input sequences associated with one or more users, each first input sequence corresponding to a user's interaction with one or more items during a current session at a user interface, predict, by the model for each first input sequence, one or more candidate items as recommendations in response to the first input sequence, provide the one or more candidate items to the user interface in response to the first input sequence during the current session, obtain feedback data that corresponds to a second input sequence representative of the user interaction with one or more items at the user interface during the current session, and determine a training dataset including a plurality of data points, each data point can correspond to a weighted score for minimizing a difference between the model prediction and the feedback data. In some embodiments, the recommender system can train the model using the training dataset to update one or more model parameters so as to minimize the prediction loss between the model prediction and the feedback data. In some embodiments, the feedback data can include user inputs based on, for example, item views, add-to-cart (ATC), purchase behavior, etc., at the user interface or at a web browser application at the user computing device. The recommender system can thereby leverage the feedback data as positive signals to finetune one or more parameters of the first model to minimize a difference between the model prediction and the user feedback. In some embodiments, the first input sequence is obtained during a first time period and the second input sequence is obtained during a second time period after the first time period, the current session of the user including the first time period and the second time period. In some embodiments, the first input sequence is obtained before the transformer model predicts the candidate items, and the second input sequence is obtained after the transformer model predicts the candidate items.

According to various embodiments, the recommender system can include data corresponding to a plurality of items. In some embodiments, the plurality of items can include the items of the first input sequence, the candidate items, the items of the second input sequence, or any combination thereof. In some embodiments, the data corresponding to the plurality of items can be stored at a data store associated with the recommender system, and the recommender system can obtain this data from the data store to perform the one or more operations in accordance with the present disclosure. In some embodiments, the plurality of items can include, but is not limited to, inventory items, products, services, electronic documents, applications, or any combination thereof. For example, the plurality of items can be representative of goods or services associated with an online merchant. In some embodiments, the dataset can include item attributes associated with the plurality of items including, but not limited to, title, image data, taxonomy, description and brand, or any combination thereof.

According to various embodiments, the recommender system can include one or more models. In some embodiments, the recommender system can include a first model (e.g., transformer model) configured to predict candidate items as recommendations based on sequential data representative of the user's interactions with a sequence of items at the user interface as input. In some embodiments, the sequential data can include one or more input sequences from one or more users and the first model can predict a set of candidate items as recommendations for each input sequence. In some embodiments, the sequential data can include an item sequence and position embeddings.

In some embodiments, the recommender system can include a second model. The second model can be configured to predict a reward value for a given input (e.g., first input sequence) that mimics the user feedback. In some embodiments, the second model can be trained using the first input sequence. In some embodiments, for each sequence, the second model can be trained using the first input sequence. In some embodiments, for each sequence, the second model can be trained using the first input sequence and each of the set of candidate items output by the first model, and the second model can generate a corresponding reward value as its predicted output of the user feedback for the given input sequence and for each of the set of candidate items. For example, the second model can generate a first reward value as its predicted output based on the first input sequence and a first candidate item of a set of candidate items, a second reward value as its predicted output for the first input sequence and a second candidate item of the set of candidate items, and so forth for each of the set of candidate items.

According to various embodiments, the recommender system can determine a training dataset. In some embodiments, the training dataset can include a plurality of data points for a batch of sessions corresponding to the one or more first input sequences of the one or more users. Each data point of the training dataset can include a weighted score for minimizing a prediction loss based on a difference between the prediction and the feedback data for each observation or session of each of the one or more users. The recommender system can then train the first model using the training dataset to update one or more parameters of the first model. In some embodiments, the first model can include a plurality of parameters. In some embodiments, each of the plurality of parameters can be associated with a corresponding item of the plurality of item. In some embodiments, each of the one or more parameters can be associated with a corresponding item of the set of candidate items.

According to various embodiments, the training methodologies of the recommender system of the present disclosure utilizes reinforcement learning with user feedback to improve the model prediction for sequential data by updating the model parameters to minimize the prediction loss over a batch of user sessions. The first model of the recommender system can thereby also be trained so as to lower costs from having manual feedback on the recommendations. The one or more embodiments of the present disclosure relate to a recommender system that can leverage an input sequence structure corresponding to one or more items viewed chronologically at respective points in time during a time period to generate the set of candidate items representative of a top predicted number of items by the prediction model and as feedback data on the set of candidate items to refine future predictions by the model without the need to utilize third-party ratings. Accordingly, the recommender system can look back to the user session and collect the feedback directly in the offline setup. In an example, the training dataset can include 2.2 M records representative of item sequences of a certain minimum length and including a purchased item and a sequence of items viewed before the item purchase, and the models of the recommender system can be trained using the training dataset. In some embodiments, each item can be represented by a vector that combines item attributes including, but not limited to, title, image, taxonomy, description, brand, etc. In an example, each item can be represented by a vector with 2,560 elements having values representative of the item attributes.

A transformer-based reinforcement learning system according to the present disclosure was validated in an experimental deployment (A/B test) within an electronic communication channel (e.g., professional customer weekly emails). The system was compared against a baseline propensity model and a default recommendation logic. The results of each comparison are described below.

Performance vs. Propensity Model: The disclosed reinforcement learning model demonstrated a statistically significant improvement in Click-Through Rate (CTR) of approximately 7.79%. Furthermore, the system achieved an online revenue per delivery lift of approximately 15.05%.

Performance vs. Default: Compared to a default recommendation logic, the disclosed reinforcement learning model demonstrated a CTR improvement of approximately 6.12%. These results indicate that the system's ability to leverage sequential user interaction data (e.g., view sequences) via Direct Preference Optimization (DPO) significantly outperforms traditional non-sequential propensity modeling in predicting user purchase intent.

Although other types of models can obtain an input sequence and analyze the sequence to understand the meaning to generate a response based on predicted tokens, these other types of models are typically, for example, large language models (LLMs) that obtain a prompt that is a sequence of words (e.g., text data) as input, and the LLM analyzes the sequence of words to understand the meaning of the input and generate a response to the prompt by sampling different sets of predicted tokens. These LLMs can utilize reinforcement learning with user feedback to train the LLMs to improve the LLM's ability to interpret the meaning of the input and to generate the response. These framework of these other types of models, however, do not utilize input sequences corresponding to user interactions with items during respective points in time during a time period for the reinforcement learning.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

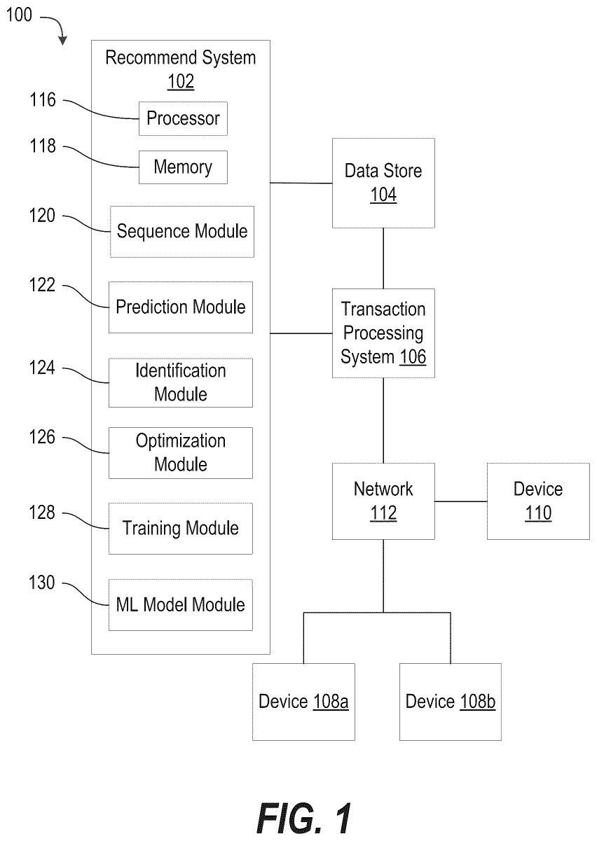

FIG. 1 is a block diagram of an example system 100 for training a base transformer model using reinforcement learning with feedback data, according to some embodiments.

The system 100 may include a reinforcement learning (RL) recommender system 102, a data store 104, a transaction processing system 106, a plurality of user computing devices 108 (two such user computing devices 108a, 108b are shown), and one or more computing devices 110. The data store 104 can include historical transaction data by the user computing devices 108. In some embodiments, the historical transaction data can be based on electronic transactions between user computing devices 108 and computing devices 110 performed using transaction processing system 106. In some embodiments, the data store 104 can include inventory data for a plurality of items. In some embodiments, the electronic transactions performed at transaction processing system 106 may be associated with the plurality of items. In some embodiments, the computing devices 110 can be associated with merchants offering goods or services on transaction processing system 106. In other embodiments, the computing devices 110 can be associated with local retail locations of an entity of system 100. The user computing devices 108 and computing devices 110 may be in electronic communication with the transaction processing system 106 and with each other over a network 112. The RL recommender system 102, data store 104 and transaction processing system 106 may also all be in electronic communication with each other via the network 112 and/or another network.

The RL recommender system 102 may include a processor 112 and a non-transitory, computer-readable memory 114 that contains instructions that, when executed by the processor, cause the RL recommender system 102 to perform one or more of the steps, processes, methods, operations, etc. described herein with respect to the RL recommender system 102. The RL recommender system 102 may include one or more functional modules embodied in the memory. The functional modules may include a sequence module 120, a prediction module 122, an identification module 124, an optimization module 126, a training module 128, and a machine learning (ML) model module 130.

The instant disclosure refers to accounts, users, interactions, and transactions and other electronic activity. Such accounts may be accounts common to a particular service provider, a particular network, a particular electronic activity processor, etc. For example, the accounts may be accounts with the transaction processing system 106, and the users may be legitimate users associated with those accounts. The electronic transactions and other activity may be transactions processed by, or other activity in or through, the transaction processing system 106, and/or transactions and activity outside of the transaction processing system 106. Although this disclosure refers to transactions as context for the novel methods and systems, it should be understood that such methods and systems may be applied to or in the context of a wide variety of computing actions, some of which may not be considered transactions. For example, where past transactions are considered herein, past computing actions may more broadly be considered. Similarly, where present transactions are responded to herein, present computing actions may more broadly be responded to.

Users may initiate transactions, review transactions, complete transactions, interact with a user interface including interacting with objects displayed at the user interface of user computing devices 108 through transaction processing system 106. In some embodiments, the objects can correspond to, for example, buttons, text, images, icons, notifications, popups, checkboxes, sliders, animations, other elements, or any combination thereof, that can be representative of items associated with an entity of system 100. In some embodiments, the objects can be associated with computing devices 110 such as, for example, a merchant performing electronic transactions on transaction processing system 106 with user computing devices 108. The items can be representative of, for example, goods, services, categories of goods, categories of services, electronic documents, medical records, etc. In some embodiments, the plurality of items can correspond to goods and/or services associated with an entity of system 100. In some embodiments, the plurality of items can correspond to goods and/or services associated with a merchant of computing devices 110.

Accordingly, the transaction processing system 106 may receive from user computing device 108 or computing device 110 instructions to perform a user query to retrieve data corresponding to one or more items that can include to display the one or more items in response to the query, an instruction to display data corresponding to the one or more items, an instruction to initiate a transaction, an instruction to accept or complete a transaction, an instruction to review one or more transactions, an instruction to retract a transaction, etc., and may respond by performing or facilitating the requested user action.

Accordingly, user activity as discussed herein may include transactions instructed through the transaction processing system 106, in some embodiments, and/or user activity on one or more platforms, networks, interfaces, etc. Such transactions may include, for example, a computing transaction such as a file creation, a revision to a file, an electronic communication, a financial transaction (or component thereof), a real-estate transaction (or component thereof), a service request, a user query, a user's interaction with one or more items at a user interface, a completed transaction for an item, or any other electronic transaction. Additionally, or alternatively, user activity according to the present disclosure may be or may include an event associated with a user, such as user views of an item, user selection of an item (e.g., add-to-cart), user navigation to a webpage, a user query, a completed electronic transaction (e.g., user purchase behavior), user interaction with one or more items, etc.

The transaction processing system 106 may be associated with a particular electronic user interface and/or platform through which a user performs electronic transactions. The electronic user interface may be embodied in a website, mobile application, etc. According, the transaction processing system 106 may be associated with or wholly or partially embodied in one or more servers, which server(s) may host the interface, and through which the user computing devices 108 may access the user interface.

The user computing devices 108 may be respectively associated with different user accounts. That is, user computing device 108a may be associated with a first user account, and user computing device 108b may be associated with a second user account. Where user computing devices are discussed herein, it may be assumed that different devices are associated with different user accounts for convenience of description, though of course a single user account may be accessed from multiple devices in practical use.

The RL recommender system 102 can include sequence module 120. The sequence module 120 can be configured to obtain input sequences based on user inputs at user computing devices 108. The input sequences can be representative of a user interaction at the user computing device with a set of items of the plurality of items. The input sequence can correspond to, for example, S of k items i1, i2 . . . ik viewed chronologically at time t1, t2, . . . tk and an item P that is purchased after viewing item ik. Based on the input sequence S, the objective of the RL recommender system 102 framework can be to predict the item to be purchased (P) such that ƒ (S)≈P. In some embodiments, the objective of the RL recommender system 102 framework can be to learn the function ƒ.

The RL recommender system 102 can obtain one or more input sequences. In some embodiments, the one or more input sequences can include one or more first input sequences. Each first input sequence can be representative of a user interaction at user computing device 108 with a first set of items of the plurality of items at respective points in time during a first time period. The first time period can correspond to an initial time period of the user session. In some embodiments, the one or more input sequences can include one or more second input sequences. Each second input sequence can be representative of the user interaction at user computing device 108 with a second set of items of the plurality of items at respective points in time during a second time period. In some embodiments, each input sequence can include a first input sequence, a second input sequence, or both the first input sequence and the second input sequence.

In some embodiments, at the RL recommender system 102, the first input sequence can be obtained during a first time period and the second input sequence can be obtained during a second time period after the first time period, the current session of the user can include the first time period and the second time period. In some embodiments, the first input sequence can be obtained before the transformer model predicts the candidate items, and the second input sequence can be obtained after the transformer model predicts the candidate items.

The RL recommender system 102 can include a prediction module 122. The prediction module 122 can be configured to leverage a first model corresponding to a base transformer model of RL recommender system 102 to predict a set of candidate items of the plurality of items as recommendations based on analyzing the first set of items of the corresponding first input sequence. The first input sequence can include one or more embeddings that can be applied to the model as input, and the model can output a prediction of a set of candidate items as top item recommendations based on the input. Each candidate item can be one of the plurality of items. Accordingly, the RL recommender system 102 or the prediction module 122 can then send the set of candidate items to the corresponding user computing device 108 in response to the first input sequence.

The RL recommender system 102 can include an identification module 124. For each first input sequence, the identification module 124 can be configured to identify a first item corresponding to a positive item example and a second item corresponding to a negative item example based on a comparison between the set of candidate items and a second set of items of a corresponding second input sequence.

To identify the first item corresponding to the positive item example for each second input sequence, the identification module 124 can identify an item associated with a completed transaction (e.g., purchased item) of the second set of items, and the identification module 124 can then determine the set of candidate items provided as recommendations in response to the first input sequence includes the item associated with the completed transaction. Assuming that the corresponding set of candidate items includes the purchased item as a predicted item, the identification module 124 can identify the purchased item as the positive item example.

To identify the second item corresponding to the negative item example, the identification module 124 can identify an item of the set of candidate items other than the first item. That is, the second item is one of the set of candidate items that did not result in the completed transaction by the user based on the second set of items. In some embodiments, the identification module 124 can randomly select the second item from the set of candidate items.

The RL recommender system 102 can include an optimization module 126. The optimization module 126 can be configured to determine one or more algorithms to fine-tune the first model and to maximize the total return from the feedback data. In some embodiments, the one or more algorithms determined by the optimization module 126 can be configured to update a layer of the first model that provides the probability of taking each action, each action corresponding to an item and a prediction that the user will purchase the item. In some embodiments, the layer of the first model that provides the probability of taking each action can be a final layer before the prediction head of the first model.

According to some embodiments, the optimization module 126 can perform a gradient based optimization of one or more parameters of the first model. In some embodiments, the optimization module 126 can be configured to determine one or more first algorithms for the one or more input sequences. In other embodiments, the optimization module 126 can be configured to determine one or more second algorithms for the one or more input sequences.

According to some embodiments, the gradient of the one or more first algorithms can increase the likelihood of positive feedback and decrease the likelihood of negative feedback. The objective function of the one or more first algorithms can be configured to optimize a binary cross-entropy loss of one or more parameters of the first model by minimizing the loss over a batch, calculated by taking the expectation over the batch size K, thereby simplifying the finetuning of the first model. In some embodiments, for each input sequence, the optimization module 126 can determine a first algorithm.

According to some embodiments, the first algorithm can be a DPO loss function represented by:

$${L}^{D P O} ( θ ) = - {𝔼}_{t ∈ K} [ log σ ( β \cdot log ( {r}_{t}^{p o s} ( θ ) ) - β \cdot log ( {r}_{t}^{n e g} ( θ ) ) ) ) ] ,$$

wherein, for each data point t, t∈K, the ratio value (rₜ) is representative of a probability of the new prediction from the first model and a probability of the old prediction from the first model for both positive and negative feedbacks, the log of ratio value (rₜ) for both positive and negative feedbacks is weighted by hyperparameter β, and the log of sigmoid function (log σ) is applied to determine the L^{DPO} (θ) over the batch, calculated by taking the expectation over the batch size K.

According to some embodiments, to determine the first algorithm for each input sequence, the optimization module 126 can be configured to calculate a ratio value (rₜ) for both positive and negative feedback for each data point t in the batch of size K. In some embodiments, the optimization module 126 can be configured to calculate a first value, or first ratio value, for the first item corresponding to the positive feedback item. In some embodiments, the optimization module 126 can be configured to calculate a second value, or second ratio value, for the second item corresponding to the negative feedback item.

According to some embodiments, to determine the first algorithm for each input sequence, the optimization module 126 can be configured to calculate a log of ratio value (rₜ) for both positive and negative feedback item for each data point t in the batch of size K. In some embodiments, the first value can be a first log of ratio value for the first item corresponding to the positive feedback. In some embodiments, the second value can be a second log of ratio value for the second item corresponding to the negative feedback.

According to some embodiments, to determine the first algorithm for each input sequence, the optimization module 126 can be configured to apply a weight to the log of ratio value (rₜ) by a hyperparameter β. In some embodiments, the first value can be a first log of ratio value weighted by the hyperparameter β. In some embodiments, the second value can be a second log of ratio value weighted by the hyperparameter β.

According to some embodiments, to determine the first algorithm for each input sequence, the optimization module 126 can be configured to calculate a log of sigmoid function to determine a loss function for each data point t across the batch of size K.

According to some embodiments, the gradient of the one or more second algorithms can look to maximize the total return for one or more parameters of the first model while ensuring that the first model does not diverge too far from the first model based on a threshold limit. The objective function of the one or more second algorithms can be to take the expectation of loss over all data points t of batch size K, and the one or more parameters of the first model can be updated to minimize the loss over each batch K. In some embodiments, for each input sequence, the optimization module 126 can determine a second algorithm.

According to some embodiments, the second algorithm can be a PPO loss function represented by:

$${L}^{CLIP} ( θ ) = - {𝔼}_{t ∈ K} [ {\sum }_{i ∈ \{ pos , neg \}} min ( {r}_{t}^{i} ( θ ) \cdot {A}_{t}^{i} , clip ( {r}_{t}^{i} ( θ ) , 1 - ϵ , 1 + ϵ ) \cdot {A}_{t}^{i} ) ] ,$$

wherein, for each data point t, t∈K, the ratio value (rₜ) is representative of a probability of the new prediction from the first model and a probability of the old prediction from the first model for both positive and negative feedbacks, the ratio value (rₜ) for both positive and negative feedbacks is clipped between 1−ϵ and 1+ϵ, the ϵ being a hyperparameter for the first model, the advantage (Aₜ) being calculated from the reward value generated using a second model (e.g., reward model), and the advantage (Aₜ) is multiplied to both the ratio value (rₜ) and the clipped ratio value (rₜ), and the minimum of the two scores is taken for each of the positive and negative examples and added together to determine the clip loss for one data point t of batch size K.

According to some embodiments, to determine the second algorithm for each input sequence, the optimization module 126 can be configured to calculate a ratio value (rₜ) for both positive and negative feedback for each data point t in the batch of size K. In some embodiments, the optimization module 126 can be configured to calculate a first value, or first ratio value, for the first item corresponding to the positive feedback. In some embodiments, the optimization module 126 can be configured to calculate a second value, or second ratio value, for the second item corresponding to the negative feedback.

According to some embodiments, to determine the first algorithm for each input sequence, the optimization module 126 can be configured to clip the first value and the second value between a limit range. In some embodiments, the optimization module 126 can be configured to clip the first value between 1−ϵ and 1+ϵ to determine a third value corresponding to the positive feedback. In some embodiments, the optimization module 126 can be configured to clip the first value between 1−ϵ and 1+ϵ to determine a fourth value corresponding to the negative feedback.

According to some embodiments, to determine the first algorithm for each input sequence, the optimization module 126 can be configured to calculate a reward value corresponding to the advantage (Aₜ) by a second model, as will be further described herein. In some embodiments, the optimization module 126 can be configured to apply the reward value to the first ratio value and the third value. In some embodiments, the optimization module 126 can be configured to apply the reward value to the second ratio value and the fourth value.

According to some embodiments, to determine the first algorithm for each input sequence, the optimization module 126 can be configured to identify a minimum of the two scores taken for each of positive and negative examples and can be added together. In some embodiments, the optimization module 126 can identify the minimum between the first ratio value and the third value. In some embodiments, the optimization module 126 can identify the minimum between the second ratio value and the fourth value. In some embodiments, the optimization module 126 can add the minimum between the first ratio value and the third value and the minimum between the second ratio value and the fourth value.

The RL recommender system 102 can include a training module 128. The training module 128 can be configured to determine a training dataset that includes a plurality of data points, each data point can correspond to a weighted score that can minimize the difference between the prediction by the first model and the feedback data. In some embodiments, for each input sequence, each data point can be a weighted score to minimize the prediction between the first model and the feedback data based on the first value and the second value. In addition, training the first model can include the training dataset being utilized to update the one or more parameters of the first model to minimize the prediction loss by the first model. In some embodiments, each data point of the plurality of data points in the training dataset can include a weighted score determined by a respective first algorithm of the one or more first algorithms. In other embodiments, each data point of the plurality of data points in the training dataset can include a weighted score determined by a respective second algorithm of the one or more second algorithms.

According to some embodiments, training the first model can include finetuning the weights of last layer. In some embodiments, training the first model can include initializing the weights at the last layer with weights trained with the first model. For example, the weights of the last layer can be initialized with weights of the transformer layer of the first model and using hyperparameter β as 0.1 and 1. In some embodiments, training the first model can include reinitializing the weights of the last layer. For example, the weights of the last layer can be reinitialized with hyperparameter β=1. It has been observed that finetuning the weights of the first model by initializing the weights at the last layer with weights of the transformer layer of the first model demonstrated improved model performance.

The RL recommender system 102 can include a machine learning (ML) model module 130. The ML model module 130 can include one or more models including a first model and a second model. In some embodiments, for each input sequence, the first model can be configured to predict a set of candidate items as recommendations in response to the first input sequence. That is, the set of candidate items corresponds to output predictions by the first model based on applying the first input sequence to the first model. In some embodiments, for each input sequence, the second model can be configured to determine a reward value that mimics the human feedback for each of the set of candidate items predicted by the first model. That is, each reward value corresponds to output predictions by the second model based on applying the first input sequence and a respective candidate item fo the set of candidate items to the second model.

According to some embodiments, the first model can include an architecture including a series of multi-head attention blocks. The first model can be configured to obtain the input sequence S={i₁, i₂, . . . , iₖ}along with position encoding {p₁, p₂, . . . , pₖ}, and the input sequence and position encodings can be passed to the series of multi-head attention blocks. The output of the last multi-head attention block of the series of multi-head attention blocks can be connected to a feed-forward layer that predicts the candidate items corresponding to the purchased item. For example, the first model can include 2 blocks of multi-head attention, where each block includes 5 attention heads. The function ƒ can thereby be trained by considering the input sequence and position encodings as a classification problem with multiple classes. In some embodiments, each node in the last layer can correspond to an item of the plurality of items of data store 104. Thus, the last layer of the series of multi-head attention blocks can include a same number of nodes as the number of the plurality of items in the data store 104. In an example, the first model can include 5.5 M parameters at the final layer. In an example, the first model can include 552 categories corresponding to nodes at the final layer.

According to some embodiments, each input item applied to the first model can include one or more embeddings. In some embodiments, each input item can have an embedding dimension of 10 for each of the items in the first set of items.

According to some embodiments, due to the number of items in the plurality of items being too large, the number of nodes in the last layer can become too large and can result in the first model including a large number of model parameters, that can result in overfitting. In some embodiments, due to the large number of items, the first model can be trained to predict only a set of top items. In other embodiments, due to the large number of items, the first model can be trained to predict only a set of best-seller items. In some embodiments, due to the large number of items, the first model can be trained to predict a category of the purchased item. In this regard, the model can include fewer nodes in the last layer and therefore fewer trainable parameters.

According to some embodiments, the first model can be trained to learn the function ƒ by selecting the best model architecture, learning rate, number of epochs, and dropouts with the help of hyperparameter tuning. The cross-entropy loss across the items/categories available in the training dataset can thereby be minimized.

According to some embodiments, the second model can include an architecture that can generate a reward value for a given input sequence (e.g., first input sequence) and a predicted response from the first model (e.g., candidate item). That is, based on the first input sequence, the first model can predict a set of candidate items as output, and the second input sequence can be obtained in response to the set of candidate items as feedback data. The feedback data can work as a ground truth to train the second model. That is, during the finetuning of the first model, the first input sequence and the recommendation item embeddings (e.g., candidate item) can be applied to the second model as input and the second model can generate the reward value representative of the predicted feedback data. In some embodiments, the second model can determine a multi-layer perceptron that can predict the reward value as a continuous variable. In some embodiments, the second model can be trained with mean squared error as the training loss. For example, a reward model can be trained with low learning rates of 0.00008 for 20 epochs and the second model can be from the 14^{th} epoch representative of the best performing reward model.

Various embodiments herein can employ artificial-intelligence models, neural network models, deep learning neural network models, deep q-learning neural network models, and/or other machine learning systems and techniques to facilitate training the models from scratch, training the models using supervised data, training the models using reinforcement learning for continual learning, determining decisions as output predictions based on applying the input sequences to the models, other processes, or any combination thereof. Although the one or more embodiments are described in the present disclosure in the context of predicting candidate items in response to a user input sequence and position embeddings, it is to be appreciated that the various embodiments can be utilized in a networked system such as, for example, system 100 for any of a plurality of purposes including, but not limited to, user search queries, user interactions, electronic transactions, fulfilling electronic transactions, completing electronic transactions, authentications, content recommendations, learning user behavior, context-based scenarios, preferences, etc. in order to facilitate the system 100 taking automated action with high degrees of confidence for the computing devices performing transactions on transaction processing system 106 using the network 112. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or ML components herein such as discussed above in context of ML model module 130 and the other functional modules of recommender system 102 in FIG. 1 can include artificial intelligence component(s) which can employ an artificial intelligence (AI) model, neural network or a neural network model, or ML or a ML model, that can learn to perform the above or below described functions (e.g., via training data and/or feedback data). In some embodiments, the RL recommender system 102 can include a machine learning model configured to utilize natural language processing (NLP) to determine a context of a user query based on text data to send to the user interface one or more items of the plurality of items. In other embodiments, the RL recommender system 102 can include a machine learning model configured to utilize one or more techniques to determine a context of the user query based on text data, image data, sequential data, other types of data, or any combination thereof. In some embodiments, the ML model can include, for example, a small language model, medium language model, large language model.

In some embodiments, the system 100 and/or the stand-in system 102 can include an ML module including an AI and/or ML model that can be trained (e.g., via supervised and/or unsupervised techniques) to perform one or more of the above or below-described functions using training data including various context conditions that correspond to various management operations. In one example, an AI and/or ML model can further learn (e.g., via supervised and/or unsupervised techniques) to perform the above or below-described functions using training data including feedback data, where such feedback data can be collected and/or stored (e.g., in memory 116 or datastore 104) by stand-in module 124 or by an ML component of stand-in system 102. In this example, such feedback data can include the various instructions described above/below that can be input, for instance, to a system herein, over time in response to observed/stored context-based information.

AI/ML components herein can initiate an operation(s) associated with the one or more functional modules 120, 122, 124, 126, 128, 130 of the RL recommender system 102 based on a defined level of confidence determined using information (e.g., feedback data). For example, based on learning to perform such functions described above using feedback data, performance information, and/or past performance information herein, an ML model herein can initiate an operation associated with providing candidate items as output predictions based on the input data corresponding to the input sequence applied to the model including position embeddings. In some embodiments, the input sequence can include one or more labels including, but not limited to, for user data, account data, device data, historical data, inventory data, user behavior data, sequence data, other types of data at RL recommender system 102 or transaction processing system 106, or any combination thereof. In another example, based on learning to perform such functions described above using feedback data, an ML model can be trained from scratch using historical behavioral data, trained using reinforcement learning, or trained using continual learning.

In an embodiment, the ML model can perform a utility-based analysis that factors cost of initiating the above-described operations versus benefit. In this embodiment, an artificial intelligence component can use one or more additional context conditions to determine an appropriate distance threshold or context information, or to determine an update for a parameter of the model.

To facilitate the above-described functions, an ML model herein can perform classifications, correlations, inferences, and/or expressions associated with principles of artificial intelligence. For instance, an ML model can employ an automatic classification system and/or an automatic classification. In one example, the ML model can employ a probabilistic analysis (e.g., factoring into the analysis probabilities between a previous iteration model and a current iteration model) to predict the candidate items. The ML model can employ any suitable machine-learning based techniques, statistical-based techniques and/or probabilistic-based techniques. For example, the ML model can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML model can perform a set of machine-learning computations. For instance, the ML model can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In some embodiments, the ML model can utilize one or more clustering techniques including, but not limited to, density-based clustering, distribution-based clustering, centroid-based clustering, hierarchical based clustering, or any combinations thereof. In addition, the one or more models can apply one or more clustering algorithms including, but not limited to, k-means clustering algorithms, density-based clustering algorithms, Gaussian mixture model algorithms, balanced iterative reducing and clustering using hierarchies (BIRCH) algorithms, propagation clustering algorithms, mean-shift clustering algorithms, order point clustering, agglomerative hierarchy clustering algorithms, other algorithms, or any combinations thereof. For example, the model can apply the one or more centroid-based clustering models to determine clusters using k-means clustering algorithms.

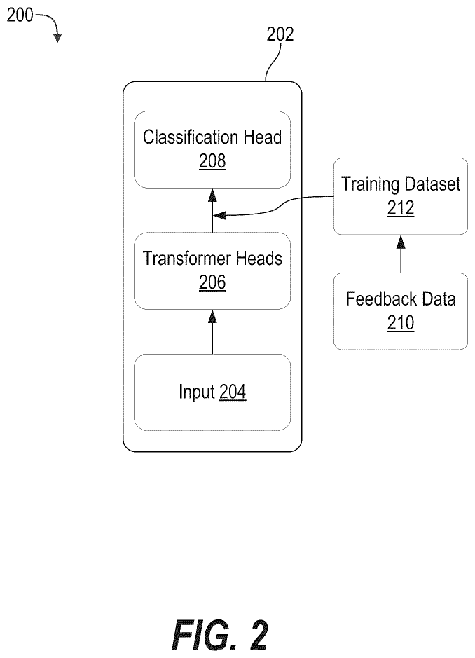

FIG. 2 is a block diagram of an example framework 200 for training a model of the RL recommender system 102 of FIG. 1 using reinforcement learning with user feedback, according to some embodiments.

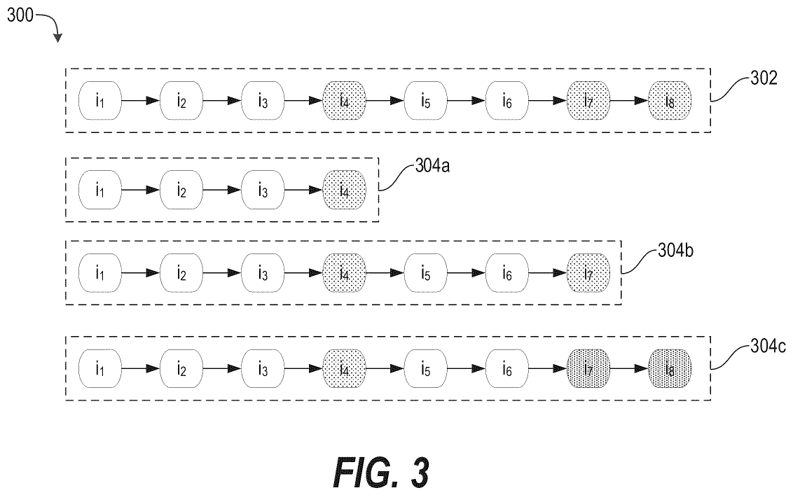

FIG. 3 is a block diagram of an example training dataset 300 for training the model of RL recommender system 102 in FIG. 1, according to some embodiments. FIGS. 2 and 3 will be described collectively.

The framework 200 can apply an input sequence 204 to the model 202. The model 202 can be trained using the input sequence 204 to learn the function (ƒ) such that the model can predict a purchased item (P). In some embodiments, the input sequence 204 can be a first input sequence representative of a user interaction at a user computing device with a first set of items of a plurality of items. In some embodiments, the input sequence 204 can be a training input sequence used to initially train the model 202. The training input sequence can include one or more training sequences. The model 202 can be trained on the training input sequence to enable the model 202 to predict items that will be purchased by a user based on a given input sequence. In some embodiments, the model 202 can be a base transformer model. In some embodiments, the model 202 can be an embodiment of the first model in FIG. 1.

The input sequence 204 can include one or more training sequences. The training sequences can be generated based on historical data. In some embodiments, the historical data can include historical user behavioral data. In some embodiments, the historical data can include historical user browsing data for one or more users. In some embodiments, the historical data can include historical user browsing data for a user of one or more users. The one or more training sequences can be generated based on one or more user input sequences determined based on the historical data, each input sequence including a sequence of items viewed by a user before an item was purchased by the user.

The model 202 can include a series of transformer heads 206. In some embodiments, the series of transformer heads 206 can include a series of attention blocks forming one or more layers. In some embodiments, the series of transformer heads 206 can be a series of self-attention blocks forming one or more layers. The weights at each of the layers of the series of transformer heads 206 can be fixed except at the last layer. This last layer can be utilized to determine the probabilities of taking each action, corresponding to the items that the model 202 predicts the user will purchase.

The weights of this last layer can be updated using a training dataset 212 to finetune the model 202 and minimize a prediction loss. The training dataset 212 can include a plurality of data points, each data point including a weight score that can be applied to corresponding nodes (e.g., neurons) of the last layer to finetune the model prediction for a given input. In addition, the training dataset 212 can be generated based on feedback data 210. The feedback data 210 can include one or more second input sequences from one or more users, each second input sequence can be in response to a corresponding first input sequence of the one or more first input sequences that is applied to the model 202, and can also be in response to a corresponding set of candidate items of the one or more sets of candidate items that is sent to the user in response to the first input sequence.

The model 202 can also include a classification head 208. The classification head 208 can be configured to select the items with the highest predicted probabilities of taking action (e.g., items with the highest probability of being purchased by the user) and output the selected items as the candidate items. For example, the model 202 can output a top 25 items corresponding to the top 25 probabilities from the model 202.

Referring to FIG. 3, a non-limiting example of an input sequence 302 of the one or more user input sequences for determining the training sequences is shown. For input sequence 302 including 8 items viewed, the user purchased item (i₄) after viewing first three items (i₁, i₂, i₃). This creates the first training sequence 304a (i₁, i₂, i₃→i₄). After buying item (i₄), user then views items (i₅) and item (i₆) and buys item (i₇) and then buys item (i₈). With 3 purchases in the session, 3 training examples 304a, 304b, 304c can be created from the input sequence 302. The purchased items can serve as the ground truth of a given sequence.

Each input sequence 302 can be configured to have a maximum length of N number of items before an item was purchased. In some embodiments, for example, the maximum length of the input sequence 302 can be set to 15 items so that the last 15 items viewed by the user before the last item was purchased. In some embodiments, if the number of items are less than the maximum length of N number of items, the input sequence 302 can be padded so that each input sequence has the same length number of items.

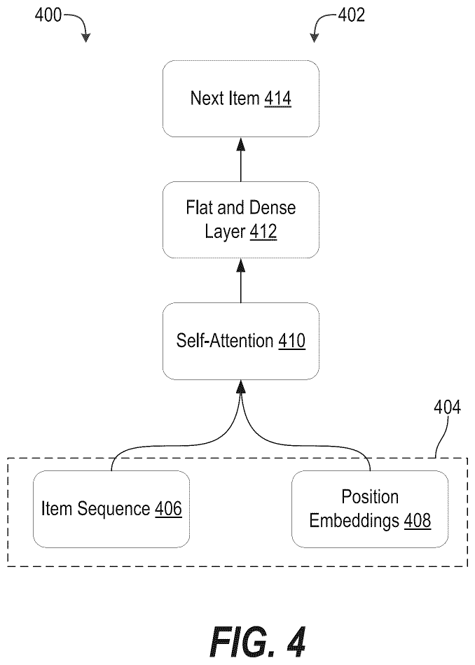

FIG. 4 is a block diagram of an example transformer model 400 of FIG. 1, according to some embodiments. The transformer model 400 can be an embodiment of the first model in the RL recommender system 102 in FIG. 1 or an embodiment of the model 202 in FIG. 2.

An input sequence 404 corresponding to a sequential dataset based on user behavior can be applied to the model 402 as input. The input sequence 404 can include an item sequence 406 and position embeddings 408 added together. The model 402 can combine the item sequence 406 and the position embeddings 408 and pass the resulting input sequence 404 to the multi-head self-attention blocks 410. The output of the multi-head self-attention blocks 410 can be flattened and connected with a dense layer 412. A final layer 414 of the model 402 can associate a label with the output embeddings from the dense layer 412, thereby encoding the output to nodes that correspond to items as the next item prediction.

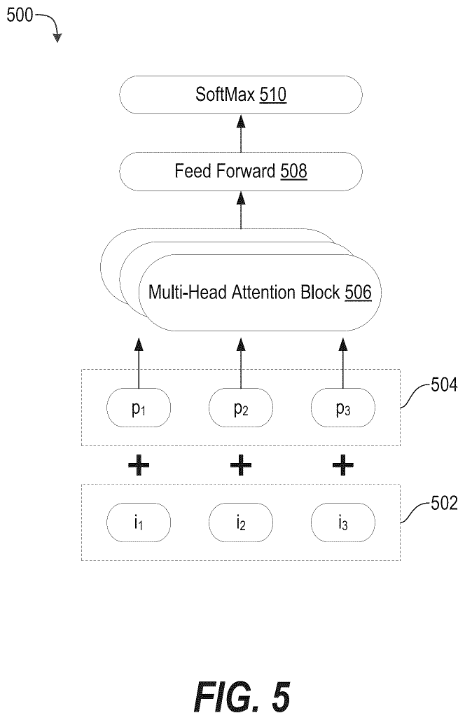

FIG. 5 is a block diagram of an example transformer model 500 of FIG. 1, according to some embodiments. The model 500 can be an embodiment of the first model of RL recommender system 102 in FIG. 1, the model 202 in FIG. 2, or the model 400 in FIG. 4.

The model 500 can be configured to obtain the input sequence 502 (S={i₁, i₂, . . . , iₖ}along with position embeddings 504 ({p₁, p₂, . . . , pₖ}), and the input sequence 502 and position embeddings 504 can be added together and passed to a series of multi-head attention blocks 506. The output of the last layer of the series of multi-head attention blocks 506 can be connected to a feed-forward layer 508 that predicts the set of candidate items corresponding to the purchased items. The model 500 can thereby be trained to consider the input sequence 502 and position embeddings 504 as a classification problem with multiple classes. In some embodiments, the last layer of the series of multi-head attention blocks 506 can include a plurality of nodes that correspond to a plurality of items, each node in the last layer of the series of multi-head attention blocks 506 thereby corresponding to an item of the plurality of items such as, for example, in data store 104. Accordingly, the last layer of the series of multi-head attention blocks 506 can include a same number of nodes as the number of the plurality of items in the data store 104.

According to some embodiments, due to the number of items in the plurality of items being too large, the number of nodes in the last layer can become too large and can result in the first model including a large number of model parameters, that can result in overfitting. In some embodiments, due to the large number of items, the input sequence 502 can be trained to predict only a set of top items. In other embodiments, due to the large number of items, the first model can be trained to predict only a set of best-seller items. In some embodiments, due to the large number of items, the first model can be trained to predict a category of the purchased item. In this regard, the model can include fewer nodes in the last layer and therefore fewer trainable parameters. According to some embodiments, the first model can be trained to learn the function ƒ by selecting the best model architecture, learning rate, number of epochs, and dropouts with the help of hyperparameter tuning. The cross-entropy loss across the items/categories available in the training dataset can thereby be minimized.

The feed-forward layer 508 can be configured to receive input from the multi-head attention blocks 506 and pass it to the SoftMax layer 510. In some embodiments, the feed-forward layer 508 can be the last layer before the SoftMax layer 510 and can include the weight values associated with each of the nodes representative of the plurality of items.

According to some embodiments, the feed-forward layer 508 can include one or more layers. The weight values can be located on the connections between neurons in different layers of the feed-forward layer 508, and the weight values can be representative of the strength between connections between each pair of neurons between corresponding adjacent layers, and these weight values can be utilized to determine the output for a given input. In some embodiments, the one or more layers can include an input layer, a hidden layer, and an output layer. In some embodiments, the hidden layer can include one or more hidden layers. The output layer can be the final layer of the model 500, and the output layer can produce the final prediction corresponding to the items predicted to be purchased by the user as output based on the input data that has been processed through the preceding layers.

According to some embodiments, the input sequence 502 can include a SoftMax layer 510. The SoftMax layer 510 can be utilized to normalize the output of the feed-forward layer 508 into a probability distribution consisting of probabilities proportional to the exponentials of the input numbers. That is, prior to the SoftMax layer 510, some vector components from the feed-forward layer 508 can have values that can be negative, greater than one, or may not sum to 1. The SoftMax layer 510 can thereby be configured to transform the output from feed-forward layer 508 so that each vector component will be in the interval (0,1) and the components will add up to 1 so that they can be interpreted as probabilities of taking each action. In some embodiments, the output of the feed-forward layer 508 can be applied to the SoftMax layer 510 to normalize the output of the feed-forward layer 508 into the probability distribution, and the top items can be selected and provided as the set of candidate items by the model 500.

In some embodiments, the recommender system may further include a hierarchical diversification filter that processes the set of candidate items output by the first model to minimize redundancy. The filter may utilize a hierarchical taxonomy of items (e.g., Level 1 ‘L1’ broad categories, Level 2 ‘L2’ sub-categories, Level 3 ‘L3’ granular categories, and so on). The system may determine a count of candidate items belonging to distinct categories at a first level (e.g., L1). If the count meets a threshold (e.g., greater than or equal to 4), the system selects a top-ranked item from each category at the first level. If the count is below the threshold, the system iteratively traverses to a deeper level of the hierarchy (e.g., L2, then L3) until a sufficient number of diverse items is obtained. This post-processing logic ensures that the final recommendations cover a broader range of user needs rather than clustering around a single product type.

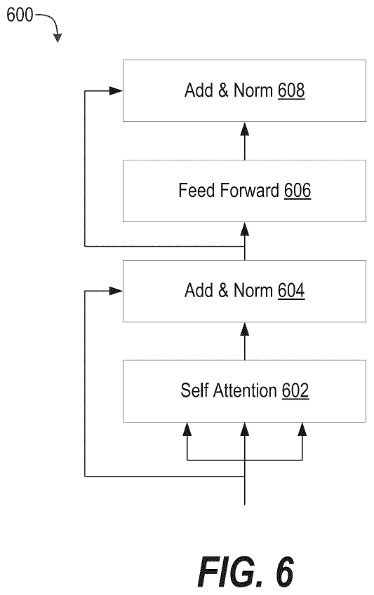

FIG. 6 is a flow diagram of an example transformer model 600 of FIG. 1, according to some embodiments. The model 600 can be an embodiment of the first model of RL recommender system 102 in FIG. 1, the model 202 in FIG. 2, the model 400 in FIG. 4, or the model 500 in FIG. 5.

The model 600 can include a series of multi-head attention blocks 602 for the input sequence. The multi-head attention blocks 602 are configured to calculate how relevant each item is to current item in the sequence, thereby allowing the model 600 to capture long-range dependencies and understand the context of each item by comparing it to the other items in the sequence. The multi-head attention blocks 602 can transform the item sequence and position embeddings into vector values (e.g., query, key, and value vectors) and can calculate attention scores based on the similarity between the query and key vectors to produce a weighted sum of the values.

The model 600 can include an add & norm layers 604 at the output of the multi-head attention blocks 602. In some embodiments, each layer (or block) of the series of multi-head attention blocks 602 can include an add & norm layer 604.

Each add & norm layer 604 can add a residual connection to the input of the preceding layer and provide layer normalization to the output of the preceding layer. The residual connection can provide stability and improve the training of the model 600 that can facilitate signal propagation in both backward and forward paths and can mitigate vanishing gradients.

The layer normalization can be applied to the output of the previous operation across the features. The output produced by neurons in a layer after applying an activation function to the weighted sum of inputs is called activations. The distribution of these activations can shift over time due to changes in network parameters. That is, each item in the batch can be normalized to mitigate this internal covariate shift so as to maintain stable distribution of activations to improve the model training. In some embodiments, the layer normalization can be a standard normal distribution by taking the mean and standard deviation of the output of the previous operation.

The model 600 can include the feed-forward layer 606. The feed-forward layer 606 can be configured to receive an input from the multi-head attention blocks 602, and the feed-forward layer 606 can provide an output that corresponds to predicted item(s) that will be purchased by the user based on the input. In some embodiments, the feed-forward layer 606 can be the last layer of the multi-head attention blocks 602 and can include the weight values associated with each of the nodes representative of each item of the plurality of items. In some embodiments, each of the nodes can be representative of categories of items of a plurality of categories for the plurality of items.

According to some embodiments, the feed-forward layer 606 can include one or more layers. The weight values can be located on the connections between neurons in different layers of the feed-forward layer 606, and the weight values can be representative of the strength between connections between each pair of neurons between corresponding adjacent layers, and these weight values can be utilized to determine the output for a given input. In some embodiments, the one or more layers can include an input layer, a hidden layer, and an output layer. In some embodiments, the hidden layer can include one or more hidden layers. The output layer can be the final layer of the feed-forward layer 606, and the feed-forward layer 606 can produce the final prediction corresponding to the items predicted to be purchased by the user as output based on the input data that has been processed through the preceding layers.

According to some embodiments, the model 600 can include an add & norm layer 608 at the output of the feed-forward layer 606. In some embodiments, the model 600 can include one or more add & norm layers 608 at an output of each layer of the feed-forward layer 606.

Each add & norm layer 608 can add a residual connection to the input of the preceding layer and provide layer normalization to the output of the preceding layer. The residual connection can provide stability and improve the training of the model 600 that can facilitate signal propagation in both backward and forward paths and can mitigate vanishing gradients.

The layer normalization can be applied to the output of the previous operation across the features. The output produced by neurons in a layer after applying an activation function to the weighted sum of inputs is called activations. The distribution of these activations can shift over time due to changes in network parameters. That is, each item in the batch can be normalized to mitigate this internal covariate shift so as to maintain stable distribution of activations to improve the model training. In some embodiments, the layer normalization can be a standard normal distribution by taking the mean and standard deviation of the output of the previous operation.

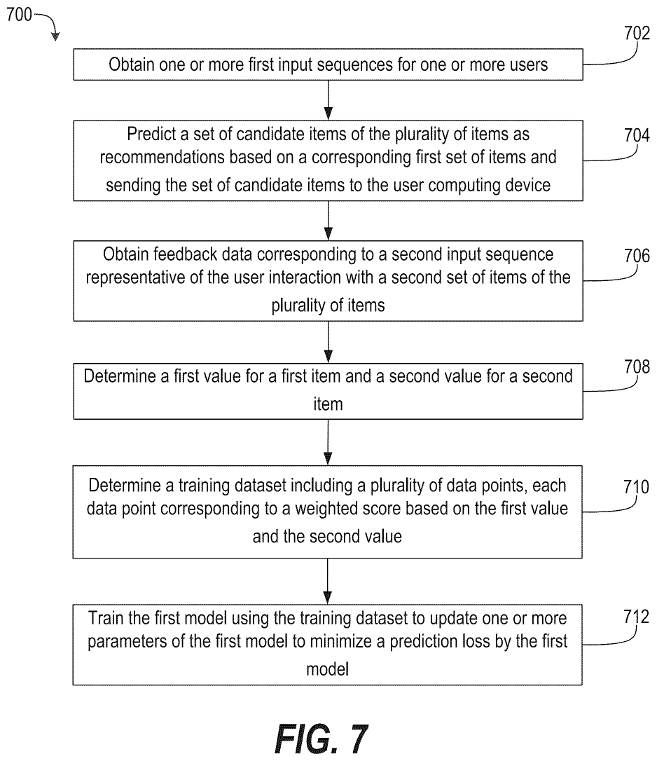

FIG. 7 is a flow diagram of an example method 700 for training the recommender system using reinforcement learning with user feedback data, according to some embodiments. The method 700, or one or more portions of the method 700, can be performed by the RL recommender system 102 in conjunction with transaction processing system 106, and thus can be computer-implemented.

At 702, the method 700 can include obtaining one or more first input sequences for one or more users. Each first input sequence can be representative of a user interaction at a user computing device. The user interactions can be based on user inputs at the user computing device with a corresponding first set of items of a plurality of items. In some embodiments, the user interactions can include a sequence of viewed items. In some embodiments, the user interactions can be at a user interface displayed at the user computing device. For example, the user interface can be displayed on a web browser application of the user computing device. In FIG. 4, the first input sequence is shown as input sequence 404. In some embodiments, each first input sequence can include a set of first item embeddings and a set of first position embeddings. In FIG. 5, the first input sequence is shown as input sequence 502 and position embeddings 504. In FIG. 1, the user computing device is shown as user computing devices 108.

At 704, the method 700 can include predicting, by a first model for each first input sequence, a set of candidate items of the plurality of items as recommendations based on the corresponding first set of items. The first input sequence can be applied to the first model, and the first model can predict a set of candidate items as output, the set of candidate items being representative of items predicted to be purchased by the user. In FIG. 4, the set of candidate items is shown as the next items at the final layer 414. In some embodiments, the operation 704 can include sending the set of candidate items to the user computing device. The set of candidate items can be displayed to the user at the user computing device.

In some embodiments, the first model can include a plurality of parameters. Each parameter can be associated with an item of the plurality of items. In some embodiments, the one or more parameters of the first model can be associated with the set of candidate items. In some embodiments, the plurality of parameters can correspond to weights associated with one or more nodes at a last layer of the first model, and the one or more parameters can correspond to nodes associated with the candidate items at the last layer.

At 706, the method 700 can include obtaining, for each first input sequence, feedback data corresponding to a second input sequence representative of the user interaction with a second set of items of the plurality of items at the user computing device. The second input sequence can be obtained in response to the set of candidate items. In some embodiments, each second input sequence can include a set of second item embeddings and a set of second position embeddings. In some embodiments, the set of second item embeddings can include a purchased item and a defined number of preceding items before the purchased item. In FIG. 2, the feedback data is shown at block 210.

According to some embodiments, the first input sequence can be during a first time period, and the second input sequence can be during a second time period. In some embodiments, the items viewed in the first input sequence can be during one or more points in time during the first time period. In some embodiments, the second time period can be after the first time period of the first input sequence and after the set of candidate items have been sent to the user computing device. In some embodiments, the items viewed in the second input sequence being during one or more points in time during the second time period.

At 708, the method 700 can include determining, for each first input sequence, a first value for a first item and a second value for a second item. The first value can be representative of a predictive probability that the first item is a positive feedback item and the second value can be representative of a predictive probability that the second item is a negative feedback item. In some embodiments, the first value for the first item and the second value for the second item can be determined based on a comparison between the set of candidate items and the second set of items. In some embodiments, the first item is one of the second set of items associated with a completed transaction (e.g., purchased item) from the second set of items of the second input sequence and can be representative of a positive feedback item. In some embodiments, the second item is one of the set of candidate items that did not result in a completed transaction and can be representative of a negative feedback item. In some embodiments, the second item is one of the set of candidate items other than the first item that did not result in a completed transaction and can be representative of a negative feedback item.

According to some embodiments, the first value can be a first ratio value that corresponds to a ratio between a probability output by the first model for the positive feedback item and a probability output by a base transformer model for the positive feedback item. In some embodiments, the second ratio value can be a second ratio value that corresponds to a ratio between a probability output by the first model for the negative feedback item and the probability output by the base transformer model for the negative feedback item.

At 710, the method 700 can include determining a training dataset including a plurality of data points. Each data point can correspond to a weighted score as discussed with respect to optimization module 126 and training module 128 in FIG. 1. The weighted scores can be calculated to minimize a difference between the model prediction and the feedback data for each second input sequence based on the first value and the second value. In FIG. 2, the training dataset is shown at block 212.

According to some embodiments, each data point in the training dataset can be determined based on a first algorithm or a second algorithm applied to the set of candidate items output by the first model and to the second input sequence obtained from the user computing device.

According to some embodiments, each data point in the training dataset can be determined based on a first algorithm applied to the set of candidate items output by the first model and to the second input sequence obtained from the user computing device. In some embodiments, the first algorithm can correspond to a DPO loss function, and for each input sequence, the weighted score can be determined based on the first item representative of the purchased item of the set of candidate items as determined based on the second set of items of the second input sequence, and the second item representative of a randomly selected item of the set of candidate items other than the first item.

According to some embodiments, each data point in the training dataset can be determined based on a second algorithm applied to the set of candidate items output by the first model and to the second input sequence obtained from the user computing device. In some embodiments, the second algorithm can correspond to a PPO loss function, and for each input sequence, the weighted score can be determined based on the first item representative of the purchased item of the set of candidate items as determined based on the second set of items of the second input sequence, and the second item representative of a randomly selected item of the set of candidate items other than the first item.

At 712, the method 700 can include training the first model using the training dataset to update one or more parameters of the first model to minimize a prediction loss by the first model. In FIG. 2, the training of the first model is shown at the connector from block 212.

According to some embodiments, the first model can include one or more attention layers, and the first model can be trained by updating one or more parameters of the one or more attention layers associated with the set of candidate items of the plurality of items based on the weighted scores of the training dataset. In some embodiments, the one or more parameters can be at a last layer of the one or more attention layers of the first model, and the one or more parameters can be associated with one or more nodes (or neurons) at the last layer. In some embodiments, the last layer can include one or more layers, and each parameter can be represented by a respective connection between a node pair at adjacent layers, and the training dataset can be utilized to update the weight values at these connections.

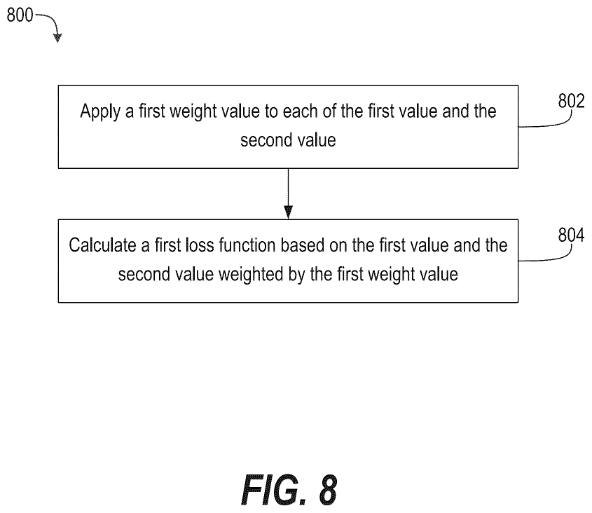

FIG. 8 is a flow diagram of an example method 800 for determining a training dataset, according to some embodiments. The method 800 can be an embodiment of operations 708, 710, 712 of the method 700 of FIG. 7. The method 800, or one or more portions of the method 800, can be performed by the RL recommender system 102 in conjunction with the transaction processing system 106, and thus can be computer-implemented.

At 802, the method 800 can include applying, for each second input sequence, a first weight value to each of the first value and the second value. In some embodiments, the first weight value can be a hyperparameter value applied to each of the first value and the second value, respectively. In some embodiments, the first weight value can be applied to a log of the first value and a log of the second value, respectively. In some embodiments, the first weight value can be a hyperparameter β, as discussed above with reference to optimization module 126 in FIG. 1.

At 804, the method 800 can include calculating a first loss function based on the first value and the second value weighted by the first weight value. The first loss function can be calculated for each data point, each data point corresponding to a first input sequence of the one or more first input sequences. In some embodiments, each of the weighted scores in the training dataset can be determined based on the first loss function. In some embodiments, the first model can be trained utilizing a gradient descent based optimization so that the one or more parameters of the first model can be updated so as to minimize the loss over a batch, calculated by taking the expectation over the batch size K for each iteration, corresponding to the one or more first input sequences.

According to some embodiments, the first loss function can include a log of sigmoid function, and calculating the first loss function can include calculating a log of sigmoid function for the weighted first value and the weighted second value, the first value and the second value being weighted by the first weight value.

According to some embodiments, calculating the first loss function can include calculating a first log function based on the first value, and calculating a second log function based on the second value. In addition, in some embodiments, the first weight value can be applied to the result of the first log function to determine the weighted first value, and the first weight value can be applied to the result of the second log function to determine the weighted second value.

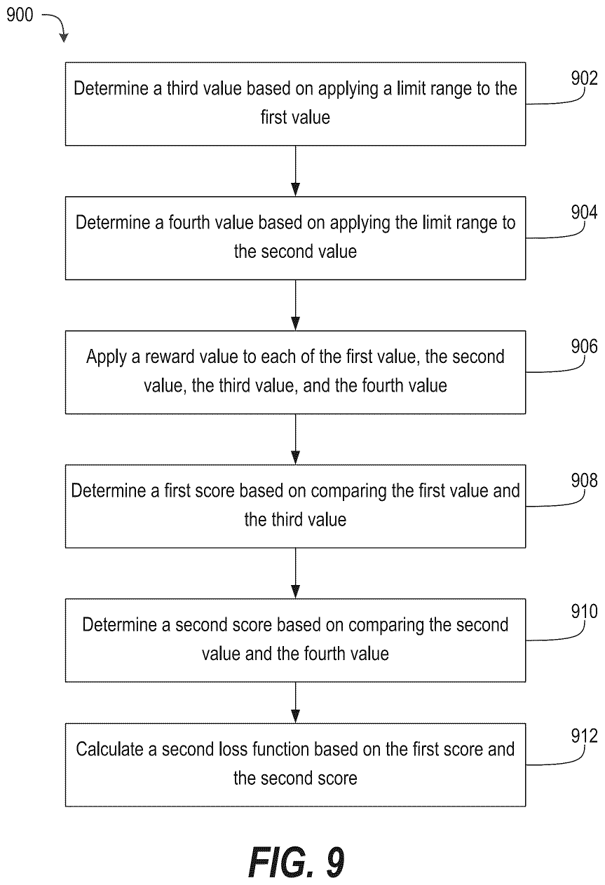

FIG. 9 is a flow diagram of an example method 900 for determining the training dataset, according to some embodiments. The method 900 can be an embodiment of operations 708, 710, 712 of the method 700 of FIG. 7. The method 900, or one or more portions of the method 900, can be performed by the RL recommender system 102 in conjunction with the transaction processing system 106, and thus can be computer-implemented.

At 902, the method 900 can include determining, for each second input sequence, a third value based on applying a limit range to the first value. In some embodiments, the limit range can be configured to clip the first value between a first limit and a second limit to limit a divergence when training the first model. In some embodiments, the limit range can be based on a second weighted value. In some embodiments, the second weighted value can be a hyperparameter. In some embodiments, the second weighted value can be a hyperparameter (ϵ). In some embodiments, the first limit and the second limit can be based on the second weighted value. In some embodiments, the first limit can have a value of (1−ϵ). In some embodiments, the second limit can have a value of (1+ϵ). In some embodiments, the limit range is configured to limit a divergence of the first model.

At 904, the method 900 can include determining, for each second input sequence, a fourth value based on applying the limit range to the second value. In some embodiments, the limit range can be configured to clip the second value between a first limit and a second limit to limit the divergence when training the first model. The limit range can be the same limit range as applied to the first value.

At 906, the method 900 can include applying, for each second input sequence, a reward value to each of the first value, the second value, the third value, and the fourth value. In some embodiments, the reward value can be determined by a second model. In some embodiments, the reward value can be an advantage (Aₜ), calculated based on the reward value from the second model, as discussed above with respect to optimization module 126.

At 908, the method 900 can include determining, for each second input sequence, a first score based on comparing the first value and the third value. In some embodiments, the first score can be the minimum between the first value and the third value for the positive feedback item.

At 910, the method 900 can include determining, for each second input sequence, a second score based on comparing the second value and the fourth value. In some embodiments, the second score can be the minimum between the second value and the fourth value for the negative feedback item.

At 912, the method 900 can include calculating a second loss function based on the first score and the second score. The second loss function can be calculated for each data point, each data point corresponding to a first input sequence of the one or more first input sequences. In some embodiments, each of the weighted scores in the training dataset can be determined based on the second loss function. In some embodiments, the first model can be trained utilizing a gradient descent based optimization so that the one or more parameters of the first model can be updated using the training dataset so as to minimize the loss over a batch, calculated by taking the expectation over the batch size K for each iteration, corresponding to the one or more first input sequences determined based on calculating the second loss function for each data point. According to some embodiments, each of the weighted scores in the training dataset can be determined based on calculating the second loss function for each input sequence of the one or more input sequences.

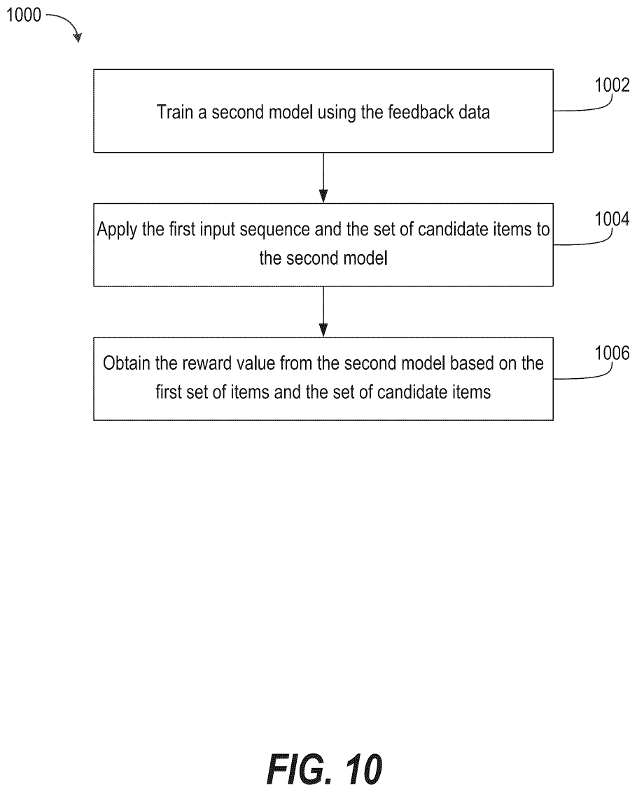

FIG. 10 is a flow diagram of an example method 1000 for determining the training dataset, according to some embodiments. The method 1000 can be an embodiment of operations 708, 710, 712 of the method 700 of FIG. 7. The method 1000 can be an embodiment of operations 906 of the method 900 of FIG. 9. The method 1000, or one or more portions of the method 1000, can be performed by the RL recommender system 102 in conjunction with the transaction processing system 106, and thus can be computer-implemented.

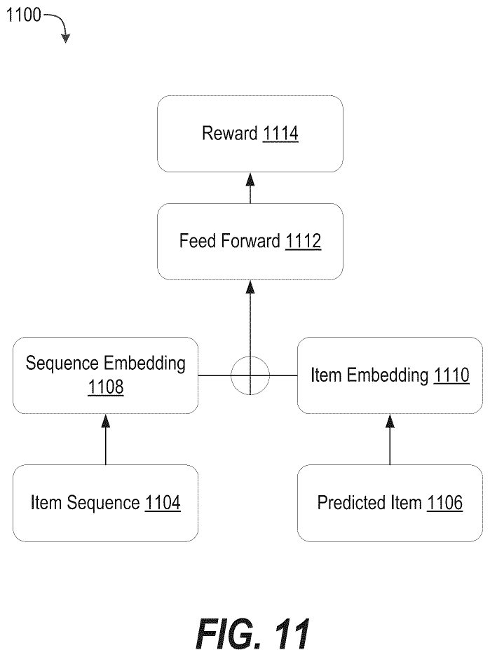

FIG. 11 is a block diagram of an example model 1100 of the RL recommender system 102 in FIG. 1, according to some embodiments. FIGS. 10 and 11 will be described collectively.

At 1002, the method 1000 can include training a second model. The second model can be trained using the first input sequence and the set of candidate items. In some embodiments, the second model can be trained using the second input sequence corresponding to the feedback data as the ground truth for training the second model. The second model can be trained using the first input sequence and a candidate item of a set of candidate items, the first input sequence including a sequence of viewed items and a position embeddings. In this regard, the second input sequence serves as the ground truth to train the second model and the reward value generated by the second model mimics the user feedback according to the first input sequence and a respective candidate item of the set of candidate items. In some embodiments, the second model can be a reward model. In FIG. 11, the second model is shown as model 1100.

At 1004, the method 1000 can include applying the first input sequence and the set of candidate items to the second model. In some embodiments, the first set of items and the set of candidate items predicted by the first model can be applied to the second model as input. In FIG. 11, the first input sequence is shown as item sequence 1104 and the set of candidate items is shown as predicted items 1106.

In some embodiments, the method 1000 can include extracting sequence embeddings based on the first input sequence and extracting item embeddings based on the set of candidate items. In FIG. 11, the sequence embeddings is shown as sequence embedding 1108 and the item embedding is shown as item embedding 1108. In some embodiments, the method 1000 can include combining the sequence embeddings and the item embeddings and applying the combined embeddings to the one or more layers of the second model. In some embodiments, the one or more layers of the second model can include a feed forward layer and the combined embeddings can be passed through the feed forward layer to provide an output corresponding to the reward value. In some embodiments, the feed forward layer can be a multi-layer perceptron (MLP) created to predict the reward value. In FIG. 11, the feed forward layer is shown as layer 1112.

At 1006, the method 1000 can include obtaining the reward value from the second model based on the first set of items of the first input sequence and the set of candidate items. In some embodiments, the reward value can be a continuous variable. As used herein, the term “continuous variable” refers to a variable that can have any value with a defined range. In FIG. 11, the reward value is shown as reward 1114. In some embodiments, the second model can be trained with mean squared error, which is a loss function that quantifies the magnitude of the error between the second model prediction and an actual output by taking the average of the squared difference between the predictions and the target values.

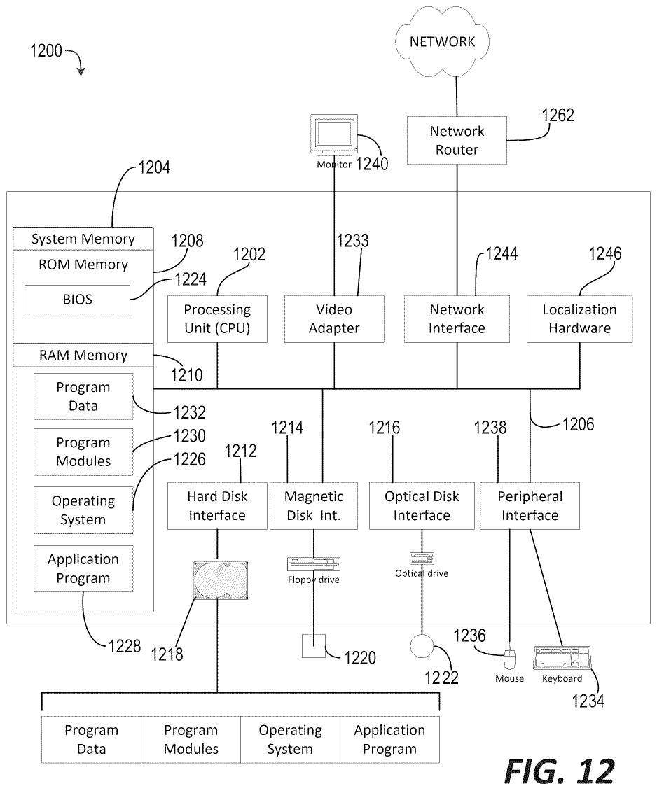

FIG. 12 is a graphical illustration of an example computing system 1200, according to some embodiments.

The computing system 1200 can be, for example, a desktop computer, laptop, smartphone, tablet, or any other such device having the ability to execute instructions, such as those stored within a non-transient, computer-readable medium. Furthermore, while described and illustrated in the context of a single computing system 1200, those skilled in the art will also appreciate that the various tasks described hereinafter can be practiced in a distributed environment having multiple computing systems 1200 linked via a local or wide-area network in which the executable instructions can be associated with and/or executed by one or more of multiple computing systems 1200.

In its most basic configuration, computing system environment 1200 typically includes at least one processing unit 1202 and at least one memory 1204, which can be linked via a bus 1206. Depending on the exact configuration and type of computing system environment, memory 1204 can be volatile (such as RAM 1210), non-volatile (such as ROM 1208, flash memory, etc.) or some combination of the two. Computing system environment 1200 can have additional features and/or functionality. For example, computing system environment 1200 can also include additional storage (removable and/or non-removable) including, but not limited to, magnetic or optical disks, tape drives and/or flash drives. Such additional memory devices can be made accessible to the computing system environment 1200 by means of, for example, a hard disk drive interface 1212, a magnetic disk drive interface 1214, and/or an optical disk drive interface 1216. As will be understood, these devices, which would be linked to the system bus 1206, respectively, allow for reading from and writing to a hard disk 1218, reading from or writing to a removable magnetic disk 1220, and/or for reading from or writing to a removable optical disk 1222, such as a CD/DVD ROM or other optical media. The drive interfaces and their associated computer-readable media allow for the nonvolatile storage of computer readable instructions, data structures, program modules and other data for the computing system environment 1200. Those skilled in the art will further appreciate that other types of computer readable media that can store data can be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media can be part of computing system environment 1200.

A number of program modules can be stored in one or more of the memory/media devices. For example, a basic input/output system (BIOS) 1224, containing the basic routines that help to transfer information between elements within the computing system environment 1200, such as during start-up, can be stored in ROM 1208. Similarly, RAM 1210, hard drive 1218, and/or peripheral memory devices can be used to store computer executable instructions comprising an operating system 1226, one or more applications programs 1228, other program modules 1230, and/or program data 1232. Still further, computer-executable instructions can be downloaded to the computing environment 1200 as needed, for example, via a network connection. The applications programs 1228 can include, for example, a browser, including a particular browser application and version, which browser application and version can be relevant to determinations of correspondence between communications and user URL requests, as described herein. Similarly, the operating system 1226 and its version can be relevant to determinations of correspondence between communications and user URL requests, as described herein.

An end-user can enter commands and information into the computing system environment 1200 through input devices such as a keyboard 1234 and/or a pointing device 1036. While not illustrated, other input devices can include a microphone, a joystick, a game pad, a scanner, etc. These and other input devices would typically be connected to the processing unit 1202 by means of a peripheral interface 1238 which, in turn, would be coupled to bus 1206. Input devices can be directly or indirectly connected to processor 1202 via interfaces such as, for example, a parallel port, game port, firewire, or a universal serial bus (USB). To view information from the computing system environment 1200, a monitor 1240 or other type of display device can also be connected to bus 1206 via an interface, such as via video adapter 1233. In addition to the monitor 1240, the computing system environment 1200 can also include other peripheral output devices, not shown, such as speakers and printers.

The computing system environment 1200 can also utilize logical connections to one or more computing system environments. Communications between the computing system environment 1200 and the remote computing system environment can be exchanged via a further processing device, such a network router 1248, that is responsible for network routing. Communications with the network router 1248 can be performed via a network interface component 1244. Thus, within such a networked environment, e.g., the Internet, World Wide Web, LAN, or other like type of wired or wireless network, it will be appreciated that program modules depicted relative to the computing system environment 1200, or portions thereof, can be stored in the memory storage device(s) of the computing system environment 1200.

The computing system environment 1200 can also include localization hardware 1246 for determining a location of the computing system environment 1200. In embodiments, the localization hardware 1246 can include, for example only, a GPS antenna, an RFID chip or reader, a WiFi antenna, or other computing hardware that can be used to capture or transmit signals that can be used to determine the location of the computing system environment 1200. Data from the localization hardware 1246 can be included in a callback request or other user computing device metadata in the methods of this disclosure.

The computing system, or one or more portions thereof, can embody a user computing device 108 or computing device 110, in some embodiments. Additionally, or alternatively, some components of the computing system 1200 can embody the stand-in system 102 and/or transaction processing system 106. For example, one or more of the functional modules 120, 122, 124, 126, 128, 130 can be embodied as program modules 1230. For example, the optimization module 126 can be embodied as program modules 1230. In another example, the identification module 124 can be embodied as program modules 1230. Some components of the computing system 1200 can embody systems 100, framework 200, and can embodiment models 400, 500, 600, 1100.

In some embodiments, a computer-implemented method for training models of a recommender system using reinforcement learning includes: obtaining one or more first input sequences for one or more users, each first input sequence representative of a user interaction at a user computing device with a corresponding first set of items of a plurality of items; predicting, by a first model for each first input sequence, a set of candidate items of the plurality of items as recommendations based on the corresponding first set of items and sending the set of candidate items to the user computing device; obtaining, for each first input sequence, feedback data corresponding to a second input sequence representative of the user interaction with a second set of items of the plurality of items at the user computing device; determining, for each first input sequence, a first value for a first item and a second value for a second item, the first value and the second value being representative of a predictive probability of the first model based on the set of candidate items and the second set of items; determining a training dataset including a plurality of data points, each data point corresponding to a weighted score based on the first value and the second value; and training the first model using the training dataset to update one or more parameters of the first model to minimize a prediction loss by the first model.

In some embodiments, according to the computer-implemented method, the first model includes a plurality of parameters, each parameter is associated with an item of the plurality of items, and wherein the one or more parameters of the first model are associated with the set of candidate items.

In some embodiments, according to the computer-implemented method, determining the training dataset further includes: applying, for each second input sequence, a first weight value to each of the first value and the second value; and calculating a first loss function based on the first value and the second value weighted by the first weight value, the weighted score being determined based on the first loss function.

In some embodiments, according to the computer-implemented method, calculating the first loss function includes calculating a log of sigmoid function based on the weighted first value and the second weighted value.

In some embodiments, according to the computer-implemented method, calculating the first loss function includes calculating a first log function based on the first value and calculating a second log function based on the second value, and the first weight value is applied to the result of the first log function to determine the weighted first value and the first weight value is applied to the result of the second log function to determine the weighted second value.

In some embodiments, according to the computer-implemented method, determining the training dataset further includes: determining, for each second input sequence, a third value based on applying a limit range to the first value; determining, for each second input sequence, a fourth value based on applying the limit range to the second value; applying, for each second input sequence, a reward value to each of the first value, the second value, the third value, and the fourth value; determining, for each second input sequence, a first score based on comparing the first value and the third value; determining, for each second input sequence, a second score based on comparing the second value and the fourth value; and calculating a second loss function based on the first score and the second score, the weighted score being determined based on the second loss function, and the limit range being configured to limit a divergence of the first model.

In some embodiments, according to the computer-implemented method, determining the training dataset further includes: training a second model using the feedback data; applying the first input sequence and the set of candidate items to the second model; and obtaining the reward value from the second model based on the first set of items and the set of candidate items.

In some embodiments, according to the computer-implemented method, the first item is one of the second set of items associated with a completed transaction and the second item is one of the set of candidate items other than the first item.

In some embodiments, according to the computer-implemented method, each first input sequence and each second input sequence includes a set of item embeddings and a set of position embeddings.

In some embodiments, according to the computer-implemented method, the first model includes one or more attention layers, and training the first model includes updating the one or more parameters associated with the set of candidate items of the plurality of items at the one or more attention layers based on the weighted score of the training dataset.

In some embodiments, a system includes: a processor; and a non-transitory computer readable media having stored thereon instructions that are executable by the processor to perform operations including: obtain one or more first input sequences for one or more users, each first input sequence representative of a user interaction with a corresponding first set of items of a plurality of items at a user computing device; predict, by a first model for each first input sequence, a set of candidate items of the plurality of items as recommendations based on the corresponding first set of items; send, in response to each first input sequence, the set of candidate items of the plurality of items to the user computing device; obtain, for each first input sequence, feedback data corresponding to a second input sequence representative of the user interaction with a second set of items of the plurality of items at the user computing device; identify, for each second input sequence, a first item and a second item based on the set of candidate items and the second set of items; determine, for each second input sequence, a first value for the first item and a second value for the second item, the first value and the second value being representative of a predictive probability of the first model based on the set of candidate items and the second set of items; determine a training dataset including a plurality of data points, each data point corresponding to a weighted score based on the first value and the second value; and train the first model using the training dataset to update one or more parameters of the first model to minimize a prediction loss by the first model, the first model includes a plurality of parameters, each parameter is associated with an item of the plurality of items, and wherein the one or more parameters of the first model are associated with the set of candidate items.

In some embodiments, according to the system, determining the training dataset further includes: apply, for each second input sequence, a first weight value to each of the first value and the second value; and calculate a first loss function based on the first value and the second value weighted by the first weight value, the weighted score being determined based on the first loss function, and calculating the first loss function includes calculating a log of sigmoid function based on the weighted first value and the second weighted value.

In some embodiments, according to the system, calculating the first loss function includes calculating a first log function based on the first value and calculating a second log function based on the second value, and the first weight value being applied to the result of the first log function to determine the weighted first value and the first weight value is applied to the result of the second log function to determine the weighted second value.

In some embodiments, according to the system, determining the training dataset further includes: determine, for each second input sequence, a third value based on applying a limit range to the first value; determine, for each second input sequence, a fourth value based on applying the limit range to the second value; train a second model using the feedback data; apply the first input sequence and the set of candidate items to the second model; obtain a reward value from the second model based on the first set of items and the set of candidate items; apply, for each second input sequence, the reward value to each of the first value, the second value, the third value, and the fourth value; determine, for each second input sequence, a first score based on comparing the first value and the third value; determine, for each second input sequence, a second score based on comparing the second value and the fourth value; and calculate a second loss function based on the first score and the second score, the weighted score being determined based on the second loss function, and the limit range being configured to limit a divergence of the first model.

In some embodiments, according to the system, the first item is one of the second set of items associated with a completed transaction and the second item is one of the set of candidate items other than the first item.

In some embodiments, according to the system, each first input sequence and each second input sequence includes a set of item embeddings and a set of position embeddings, and the first model includes one or more attention layers, and training the first model includes updating the one or more parameters associated with the set of candidate items of the plurality of items at the one or more attention layers based on the weighted score of the training dataset.

In some embodiments, a computer-implemented method for providing a recommender neural network model trained using reinforcement learning, the method includes: obtaining a first input sequence, the first input sequence representative of a user interaction with a first set of items of a plurality of items at a user computing device; predicting, by a first neural network model, a set of candidate items of the plurality of items as recommendations based on the first set of items; obtaining feedback data corresponding to a second input sequence representative of the user interaction with a second set of items of the plurality of items at the user computing device; determining a first value for a first item and a second value for a second item, the first value and the second value being representative of a predictive probability of the first neural network model based on the set of candidate items and the second set of items; determining a training dataset including a plurality of data points, each data point corresponding to a weighted score based on the first value and the second value; and training the first neural network model using the training dataset to update one or more parameters of a plurality of parameters of the first neural network model to minimize a prediction loss by the first neural network model, each parameter being associated with a respective item of the plurality of items, and the one or more parameters being associated with the set of candidate items, the first item being one of the second set of items associated with a completed transaction and the second item is one of the set of candidate items other than the first item.

In some embodiments, according to the computer-implemented method, determining the training dataset further includes: applying a first weight value to each of the first value and the second value, the first value being a first log of ratio function representative of the predictive probability of the first neural network model based on the first item, and the second value being a second log of ratio function representative of the predictive probability of the first neural network model based on the second item; and calculating a first loss function based on the first value and the second value weighted by the first weight value, the weighted score being determined based on the first loss function, and calculating the first loss function includes calculating a log of sigmoid function based on the weighted first value and the second weighted value.

In some embodiments, according to the computer-implemented method, determining the training dataset further includes: determining a third value based on applying a limit range to the first value; determining a fourth value based on applying the limit range to the second value; training a second neural network model using the feedback data; applying the first set of items and the set of candidate items to the second neural network model; obtaining a reward value from the second neural network model based on the first set of items and the set of candidate items; applying the reward value to each of the first value, the second value, the third value, and the fourth value; determining a first score based on comparing the first value and the third value; determining a second score based on comparing the second value and the fourth value; and calculating a second loss function based on the first score and the second score, the weighted score being determined based on the second loss function, and the limit range being configured to limit a divergence of the first neural network model.

In some embodiments, according to the computer-implemented method, each first input sequence and each second input sequence includes a set of item embeddings and a set of position embeddings, and the first neural network model includes one or more attention layers, and training the first neural network model includes updating the one or more parameters associated with the set of candidate items of the plurality of items at the one or more attention layers based on the weighted score of the training dataset.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties. Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method for training models of a recommender system using reinforcement learning, the computer-implemented method comprising:
obtaining one or more first input sequences for one or more users, each first input sequence representative of a user interaction at a user computing device with a corresponding first set of items of a plurality of items;
predicting, by a first model for each first input sequence, a set of candidate items of the plurality of items as recommendations based on the corresponding first set of items and sending the set of candidate items to the user computing device;
obtaining, for each first input sequence, feedback data corresponding to a second input sequence representative of the user interaction with a second set of items of the plurality of items at the user computing device;
determining, for each first input sequence, a first value for a first item and a second value for a second item, the first value and the second value being representative of a predictive probability of the first model based on the set of candidate items and the second set of items;
determining a training dataset comprising a plurality of data points, each data point corresponding to a weighted score based on the first value and the second value; and
training the first model using the training dataset to update one or more parameters of the first model to minimize a prediction loss by the first model.

2. The computer-implemented method of claim 1, wherein the first model comprises a plurality of parameters, each parameter is associated with an item of the plurality of items, and wherein the one or more parameters of the first model are associated with the set of candidate items.

3. The computer-implemented method of claim 1, wherein determining the training dataset further comprises:
applying, for each second input sequence, a first weight value to each of the first value and the second value; and
calculating a first loss function based on the first value and the second value weighted by the first weight value,
wherein the weighted score is determined based on the first loss function.

4. The computer-implemented method of claim 3 wherein calculating the first loss function comprises calculating a log of sigmoid function based on the weighted first value and the second weighted value.

5. The computer-implemented method of claim 4, wherein calculating the first loss function comprises calculating a first log function based on the first value and calculating a second log function based on the second value, and wherein the first weight value is applied to the result of the first log function to determine the weighted first value and the first weight value is applied to the result of the second log function to determine the weighted second value.

6. The computer-implemented method of claim 1, wherein determining the training dataset further comprises:
determining, for each second input sequence, a third value based on applying a limit range to the first value;
determining, for each second input sequence, a fourth value based on applying the limit range to the second value;
applying, for each second input sequence, a reward value to each of the first value, the second value, the third value, and the fourth value;
determining, for each second input sequence, a first score based on comparing the first value and the third value;
determining, for each second input sequence, a second score based on comparing the second value and the fourth value; and
calculating a second loss function based on the first score and the second score,
wherein the weighted score is determined based on the second loss function, and wherein the limit range is configured to limit a divergence of the first model.

7. The computer-implemented method of claim 6, wherein determining the training dataset further comprises:
training a second model using the feedback data;
applying the first input sequence and the set of candidate items to the second model; and
obtaining the reward value from the second model based on the first set of items and the set of candidate items.

8. The computer-implemented method of claim 1, wherein the first item is one of the second set of items associated with a completed transaction and the second item is one of the set of candidate items other than the first item.

9. The computer-implemented method of claim 1, wherein each first input sequence and each second input sequence comprises a set of item embeddings and a set of position embeddings.

10. The computer-implemented method of claim 9, wherein the first model comprises one or more attention layers, and wherein training the first model comprises updating the one or more parameters associated with the set of candidate items of the plurality of items at the one or more attention layers based on the weighted score of the training dataset.

11. A system comprising:
a processor; and
a non-transitory computer readable media having stored thereon instructions that are executable by the processor to perform operations comprising:
obtain one or more first input sequences for one or more users, each first input sequence representative of a user interaction with a corresponding first set of items of a plurality of items at a user computing device;
predict, by a first model for each first input sequence, a set of candidate items of the plurality of items as recommendations based on the corresponding first set of items;
send, in response to each first input sequence, the set of candidate items of the plurality of items to the user computing device;
obtain, for each first input sequence, feedback data corresponding to a second input sequence representative of the user interaction with a second set of items of the plurality of items at the user computing device;
identify, for each second input sequence, a first item and a second item based on the set of candidate items and the second set of items;
determine, for each second input sequence, a first value for the first item and a second value for the second item, the first value and the second value being representative of a predictive probability of the first model based on the set of candidate items and the second set of items;
determine a training dataset comprising a plurality of data points, each data point corresponding to a weighted score based on the first value and the second value; and
train the first model using the training dataset to update one or more parameters of the first model to minimize a prediction loss by the first model,
wherein the first model comprises a plurality of parameters, each parameter is associated with an item of the plurality of items, and wherein the one or more parameters of the first model are associated with the set of candidate items.

12. The system of claim 11, wherein determining the training dataset further comprises:
apply, for each second input sequence, a first weight value to each of the first value and the second value; and
calculate a first loss function based on the first value and the second value weighted by the first weight value,
wherein the weighted score is determined based on the first loss function, and wherein calculating the first loss function comprises calculating a log of sigmoid function based on the weighted first value and the second weighted value.

13. The system of claim 12, wherein calculating the first loss function comprises calculating a first log function based on the first value and calculating a second log function based on the second value, and wherein the first weight value is applied to the result of the first log function to determine the weighted first value and the first weight value is applied to the result of the second log function to determine the weighted second value.

14. The system of claim 11, wherein determining the training dataset further comprises:
determine, for each second input sequence, a third value based on applying a limit range to the first value;
determine, for each second input sequence, a fourth value based on applying the limit range to the second value;
train a second model using the feedback data;
apply the first input sequence and the set of candidate items to the second model;
obtain a reward value from the second model based on the first set of items and the set of candidate items;
apply, for each second input sequence, the reward value to each of the first value, the second value, the third value, and the fourth value;
determine, for each second input sequence, a first score based on comparing the first value and the third value;
determine, for each second input sequence, a second score based on comparing the second value and the fourth value; and
calculate a second loss function based on the first score and the second score,
wherein the weighted score is determined based on the second loss function, and wherein the limit range is configured to limit a divergence of the first model.

15. The system of claim 11, wherein the first item is one of the second set of items associated with a completed transaction and the second item is one of the set of candidate items other than the first item.

16. The system of claim 11, wherein each first input sequence and each second input sequence comprises a set of item embeddings and a set of position embeddings, and wherein the first model comprises one or more attention layers, and wherein training the first model comprises updating the one or more parameters associated with the set of candidate items of the plurality of items at the one or more attention layers based on the weighted score of the training dataset.

17. A computer-implemented method for providing a recommender neural network model trained using reinforcement learning, the method comprising:
obtaining a first input sequence, the first input sequence representative of a user interaction with a first set of items of a plurality of items at a user computing device;
predicting, by a first neural network model, a set of candidate items of the plurality of items as recommendations based on the first set of items;
obtaining feedback data corresponding to a second input sequence representative of the user interaction with a second set of items of the plurality of items at the user computing device;
determining a first value for a first item and a second value for a second item, the first value and the second value being representative of a predictive probability of the first neural network model based on the set of candidate items and the second set of items;
determining a training dataset comprising a plurality of data points, each data point corresponding to a weighted score based on the first value and the second value; and
training the first neural network model using the training dataset to update one or more parameters of a plurality of parameters of the first neural network model to minimize a prediction loss by the first neural network model, each parameter being associated with a respective item of the plurality of items, and the one or more parameters being associated with the set of candidate items,
wherein the first item is one of the second set of items associated with a completed transaction and the second item is one of the set of candidate items other than the first item.

18. The computer-implemented method of claim 17, wherein determining the training dataset further comprises:
applying a first weight value to each of the first value and the second value, the first value being a first log of ratio function representative of the predictive probability of the first neural network model based on the first item, and the second value being a second log of ratio function representative of the predictive probability of the first neural network model based on the second item; and
calculating a first loss function based on the first value and the second value weighted by the first weight value,
wherein the weighted score is determined based on the first loss function, and wherein calculating the first loss function comprises calculating a log of sigmoid function based on the weighted first value and the second weighted value.

19. The computer-implemented method of claim 17, wherein determining the training dataset further comprises:
determining a third value based on applying a limit range to the first value;
determining a fourth value based on applying the limit range to the second value;
training a second neural network model using the feedback data;
applying the first set of items and the set of candidate items to the second neural network model;
obtaining a reward value from the second neural network model based on the first set of items and the set of candidate items;
applying the reward value to each of the first value, the second value, the third value, and the fourth value;
determining a first score based on comparing the first value and the third value;
determining a second score based on comparing the second value and the fourth value; and
calculating a second loss function based on the first score and the second score,
wherein the weighted score is determined based on the second loss function, and wherein the limit range is configured to limit a divergence of the first neural network model.

20. The computer-implemented method of claim 17, wherein each first input sequence and each second input sequence comprises a set of item embeddings and a set of position embeddings, and wherein the first neural network model comprises one or more attention layers, and wherein training the first neural network model comprises updating the one or more parameters associated with the set of candidate items of the plurality of items at the one or more attention layers based on the weighted score of the training dataset.
